(19) United States
(12) Patent Application Publication
(10) Pub. No.: US 2014/0256172 A1
(43) Pub. Date: Sep. 11, 2014

(54) POWER SUPPLYING PLUG LOCK DEVICE

(71) Applicants: Masashi Kakizaki, Aichi (JP); Masaru Sasaki, Toyota-shi (JP)

(72) Inventors: Masashi Kakizaki, Aichi (JP); Masaru Sasaki, Toyota-shi (JP)

(73) Assignees: TOYOTA JIDOSHA KABUSHIKI KAISHA, Aichi-ken (JP); KABUSHIKI KAISHA TOKAI RIKA DENKI SEISAKUSHO, Aichi (JP)

(21) Appl. No.: 14/241,981

(22) PCT Filed: Aug. 1, 2012
(86) PCT No.: PCT/JP2012/004879

§ 371 Date: May 1, 2014

(30) Foreign Application Priority Data
Sep. 5, 2011 (JP) 2011-192988

(51) Int. Cl. H01R 13/627

(52) U.S. Cl. CPC H01R 13/627
USPC 439/350

(57) ABSTRACT

A power supplying plug lock device attachable to an operation arm of a power supplying plug, the operation arm operable to fix the power supplying plug to an inlet, is configured to restrict movement of the operation arm to prevent unauthorized removal of the power supplying plug. The power supplying plug lock device is externally attachable to the operation arm when an authentication member accomplishes authentication. A restriction member moves from an open position to a close position to engage with the operation arm when the power supplying plug lock device is attached to the operation arm. A position holding mechanism shifts to a lock state in cooperation with the movement of the restriction member to the close position, thereby holding the restriction member at the close position. The position holding mechanism maintains the lock state until the authentication member again accomplishes authentication.

### FIELD

The present invention relates to a power supplying plug lock device that prevents unauthorized removal of a power supplying plug.

### BACKGROUND

People have become more aware of environmental problems. Thus, vehicles having low carbon dioxide emissions, such as hybrid vehicles and electric vehicles, have become popular. In such a vehicle, a battery powers a motor to produce torque that drives the vehicle. When the vehicle travels over a long distance and the state of charge of the battery becomes low, the battery has to be charged (refer to, for example, patent literature 1). In the system of patent literature 1, a power supplying plug, which is arranged on the distal end of a charging cable, is connected to a vehicle to charge a vehicle battery.

Battery charging involves electrolytic reactions of compounds and ions in battery cells of the battery. This relatively lengthens the charging time. Thus, a user would leave the vehicle when the battery is being charged. In such a case, someone may remove the power supplying plug from the vehicle and steal electricity. It is thus desirable that a vehicle including a rechargeable battery be provided with a power supplying plug lock device that prevents unauthorized removal of a power supplying plug from the vehicle.

### CITATION LIST

### Patent Literature

### [PTL 1]

### Japanese Laid-Open Patent Publication No. 9-161898

### SUMMARY

### Technical Problem

A padlock is one example of a power supplying plug lock device that locks a power supplying plug to an inlet of a vehicle with a lock arm. However, with such a lock device, when locking the power supplying plug, the user is required to remove a shackle from the padlock and then fit the shackle back into a padlock hole. Thus, locking with the padlock is burdensome. Further, padlocks are widely available in the market. Thus, when charging is performed without locking the power supplying plug, someone may use a commercially available padlock to lock the power supplying plug without permission.

The present invention provides a power supplying plug lock device that allows for easy locking of a power supplying plug to an inlet.

### Solution to Problem

One aspect of the present invention is a power supplying plug lock device that restricts operation of an operation arm, which is used to fix a power supplying plug to an inlet, to prevent unauthorized removal of the power supplying plug. The power supplying plug lock device includes an authentication member used for authentication, a restriction member that is engageable with the operation arm, and a position holding mechanism that is able to hold the restriction member at a position engaged with the operation arm. The restriction member is configured to move from an open position to a close position to engage with the operation arm by attachment of the power supplying plug lock device to the operation arm. The position holding mechanism is configured to shift from an unlock state to a lock state in cooperation with the movement of the restriction member from the open position to the close position thereby holding the restriction member at the close position and to maintain the lock state until the authentication member accomplishes authentication.

In this structure, the power supplying plug may be locked to the inlet just by attaching the power supplying plug lock device to the operation arm. This allows for the power supplying plug to be locked by performing a simple task. Further, the power supplying plug lock device of this structure has to be possessed to lock the power supplying plug. This prevents unauthorized locking by an unauthorized person.

In the power supplying plug lock device, the restriction member may be one of two restriction members arranged to move toward and away from each other. In this case, the position holding mechanism may be configured to be shifted to the lock state when the two restriction members are both moved.

In this structure, the power supplying plug lock device does not switch to a lock state even when the one of the two restriction members is inadvertently pushed. This prevents inadvertent switching to a lock state.

In the power supplying plug lock device, the position holding mechanism may include a movable member, a lock member, and an urging member. The movable member is movable between an unlock position and a lock position. The movable member is configured to be coupled to the authentication member at the unlock position and restrict movement of the restriction member at the lock position. The lock member is movable between a first position and a second position and is configured to permit movement of the movable member to the lock position when located at the second position. The urging member is configured to urge the movable member from the unlock position to the lock position. The movable member is configured to start movement from the unlock position to the lock position with an urging force of the urging member when the restriction member moves to the open position and fix the lock member at the second position to hold the restriction member at the close position when located at the lock position.

In this structure, the power supplying plug may be locked with a simple structure that uses the movable member and the lock member.

In the power supplying plug lock device, the lock member may include a fitting groove into which the movable member is fitted. Further, the restriction member may include a restriction surface that restricts, when the restriction member moves to the open position, movement of the movable member to the lock position to maintain the movable member in a state incompletely fitted to the fitting groove of the lock member.

In this structure, the lock device is prevented from shifting to the lock state against the user's will before attaching the lock device to the power supplying plug. For example, the restriction surface of the restriction member maintains the movable member in an incompletely fitted state even when the user touches and slightly moves the restriction member. This prevents the lock device from being inadvertently shifted to a lock state.

In the power supplying plug lock device, the movable member may be a single component. Further, the lock member may be one of two lock members fixed at the second position by the movable member.

In this structure, the power supplying plug may be locked with a simple structure using one movable member and two lock members.

The power supplying plug lock device may further include an unlock portion operated to release the position holding mechanism from the lock state and return the position holding mechanism to the unlock state.

In this structure, by operating the unlock portion, the unlock portion may be operated to release the position holding mechanism from the lock state and shift the position holding mechanism to the unlock state. Thus, the power supplying plug lock device may easily be removed from the power supplying plug.

In the power supplying plug lock device, the restriction member may include a curved guide surface that guides the movement of the restriction member when the restriction member is engaged with the operation arm.

In this structure, the guide surface guides the movement of the restriction member when the power supplying plug lock device is attached to the operation arm. Thus, the power supplying plug lock device may be smoothly attached to the operation arm.

In the power supplying plug lock device, the restriction member may include a separation prevention corner that prevents separation of the operation arm from the restriction member held at the close position.

In this structure, the power supplying plug may be kept locked in a preferable manner.

In the power supplying plug lock device, the position holding mechanism may includes a movable member, a lock member, and an urging member. The movable member is movable between an unlock position and a lock position and is configured to be coupled to the authentication member at the unlock position and restrict movement of the restriction member at the lock position. The lock member is movable between a first position and a second position and configured to permit movement of the movable member to the lock position when located at the second position. The urging member is configured to urge the movable member from the unlock position to the lock position. The movable member is configured to: start moving from the unlock position to the lock position with an urging force of the urging member when the restriction member moves to the open position; be incompletely fitted to the lock member thereby fixing the lock member at the second position when the restriction member is located at the open position; finish movement to the lock position when the restriction member moves from the open position to the close position; and be completely fitted to the lock member thereby holding the restriction member at the close position when the movable member is located at the lock position.

In this structure, the lock device is prevented from shifting to the lock state against the user's will before attaching the lock device to the power supplying plug. For example, the restriction surface of the restriction member maintains the movable member in an incompletely fitted state even when the user touches and slightly moves the restriction member. This prevents the lock device from being inadvertently shifted to a lock state. Further, the power supplying plug may be kept lock in an appropriate manner as long as the movable member shifts to the completely fitted state.

In the power supplying plug lock device, the unlock portion may include an unlock button operated by a user. The unlock portion switches the position holding mechanism from the lock state to the unlock state and moves the restriction member from the close position to the open position when the unlock button is operated.

In this structure, the power supplying plug may easily be unlocked.

In the power supplying plug lock device, the authentication member is a dial cylinder including a plurality of dials used to set an authentication number.

In this structure, the dial cylinder is arranged in the power supplying plug lock device to perform authentication. Thus, the user does not have to carry a separate key. This improves convenience.

### BRIEF DESCRIPTION OF DRAWINGS

FIG. 1 is a schematic block diagram of a hybrid vehicle in one embodiment;

FIG. 2 is a perspective view showing a power supplying plug and an inlet of a charging system in the hybrid vehicle of FIG. 1;

FIG. 3 is a side view showing the power supplying plug and inlet of FIG. 2;

FIG. 4A is a perspective view showing a front side of a power supplying plug lock device in the hybrid vehicle of FIG. 1;

FIG. 4B is a perspective view showing a rear side of the power supplying plug lock device of FIG. 4A;

FIG. 5 is a front view showing the power supplying plug lock device in an unlock state;

FIG. 6 is a side view showing the power supplying plug lock device in the unlock state;

FIG. 7 is a front view showing the power supplying plug lock device in a lock state;

FIG. 8 is a side view showing the power supplying plug lock device in the lock state;

FIG. 9A is a perspective view showing the movement of a lock plate and two locking bars;

FIG. 9B is a perspective view showing the locking bar in a state incompletely fitted to the two locking bars;

FIG. 9C is a perspective view showing the locking bar in a state completely fitted to the two locking bars;

FIG. 10A is a schematic front view showing a link mechanism;

FIG. 10B is an enlarged plane view showing a top part of two links;

FIG. 11A is a front view showing the power supplying plug lock device during a lock operation (incompletely fitted state);

FIG. 11B is a front view showing the power supplying plug lock device during a lock operation (completely fitted state); and

FIG. 12 is a side view showing a side view of the power supplying plug lock device during an unlocking operation.

### DESCRIPTION OF EMBODIMENTS

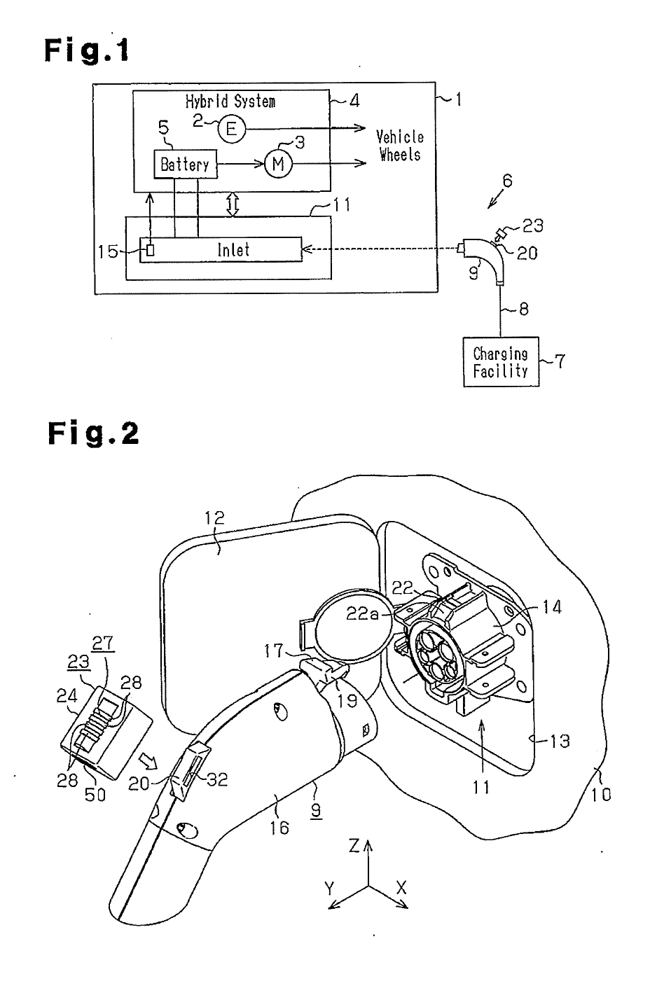

One embodiment of a power supplying plug lock device for use with a hybrid vehicle (hereafter, referred to as the vehicle 1) will now be described with reference to FIGS. 1 to 12.

Referring to FIG. 1, the vehicle 1 includes a hybrid system 4 that uses at least one of an engine 2 and a motor 3 to generate torque for driving vehicle wheels. A battery 5 is arranged in the hybrid system 4 as a power supply for the motor 3. A charging system 6 that charges the battery 5 with an external power supply is applied to the vehicle 1. The charging system 6 includes a power supplying plug 9. The power supplying plug 9 is arranged on the distal end of a charging cable 8, which is connected to a charging facility, such as a charging station or a household commercial power supply. The power supplying plug 9 is connected to the vehicle 1 to charge the battery 5.

As shown in FIGS. 1 and 2, a side wall of a vehicle body 10 includes a power receiving connector 11, which is where the power supplying plug 9 is connected. A lid 12, which is coupled to the vehicle body 10 by a hinge, opens and closes an accommodation compartment 13, which accommodates the power receiving connector 11. An inlet 14, which includes electric connection terminals, such as a power terminal and a control terminal, is arranged in the power receiving connector 11. A plug connection detection sensor 15 is arranged in the inlet 14 to detect that the power supplying plug 9 has been completely fitted to the inlet 14.

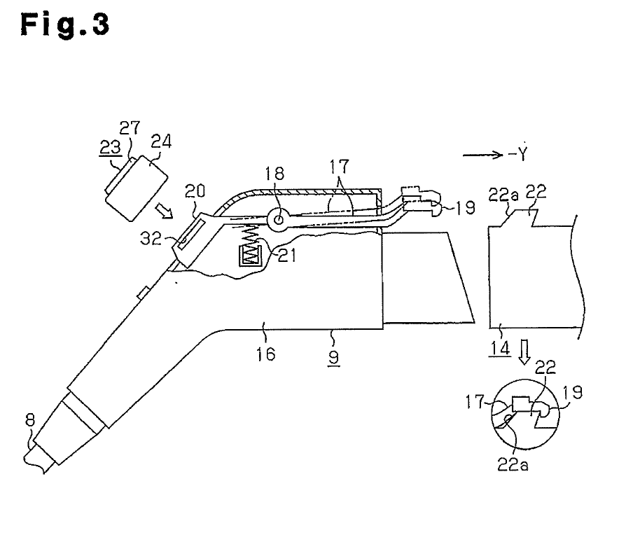

As shown in FIGS. 2 and 3, the power supplying plug 9 includes electric connection terminals, such as a power terminal and a control terminal, corresponding to the electric connection terminals of the power receiving connector 11. The power supplying plug 9 includes a plug body 16. A lock arm 17 is arranged on the plug body 16 to prevent removal of the power supplying plug 9 from the inlet 14. A pivot shaft 18 is arranged in a longitudinally middle part of the lock arm 17. The pivot shaft 18 is pivotal about the pivot shaft 18. The lock arm 17 includes a distal end defining a hook 19 and a basal end defining an arm operation portion 20. The hook 19 and the arm operation portion 20 are exposed from the plug body 16. An urging member 21 is arranged on the lock arm 17 near the arm operation portion 20 to urge the lock arm 17 toward a closing side. The lock arm 17 is one example of an operation arm.

To connect the power supplying plug 9 to the power receiving connector 11, the power supplying plug 9 is fitted straight into the inlet 14 along a fitting direction (in FIG. 3, the minus Y direction). When the hook 19 comes into contact with a projection 22 of the inlet 14, the lock arm 17 is guided along a sloped surface 22a and moved upward on the projection 22. When the power supplying plug 9 is completely fitted to the inlet 14, the urging force of the urging member 21 pivots the lock arm 17 toward the closing side and hooks the hook 19 to the projection 22. This prevents removal of the power supplying plug 9 from the inlet 14.

When it is determined with the plug connection detection sensor 15 that the power supplying plug 9 has been completely fitted to the inlet 14, the hybrid system 4 starts supplying power from the charging facility 7 via the power supplying plug 9 to charge the battery 5. When it is determined that the battery 5 has been fully charged, the hybrid system 4 ends the charging of the battery 5. To remove the power supplying plug 9 from the inlet 14 after the charging ends, the arm operation portion 20 is pushed to move the lock arm 17 toward an opening side and separate the hook 19 from the projection 22. In this state, the power supplying plug 9 is pulled straight out of the inlet 14 and removed from the vehicle 1.

As shown in FIGS. 2 and 3, a power supplying plug lock device 23 is arranged on the power supplying plug 9 to prevent unauthorized removal of the power supplying plug 9 from the inlet 14. That is, the power supplying plug lock device 23 locks and prohibits operation of the power supplying plug 9. The power supplying plug lock device 23 is attached to the lock arm 17 of the power supplying plug 9 to lock the power supplying plug 9 to the inlet 14.

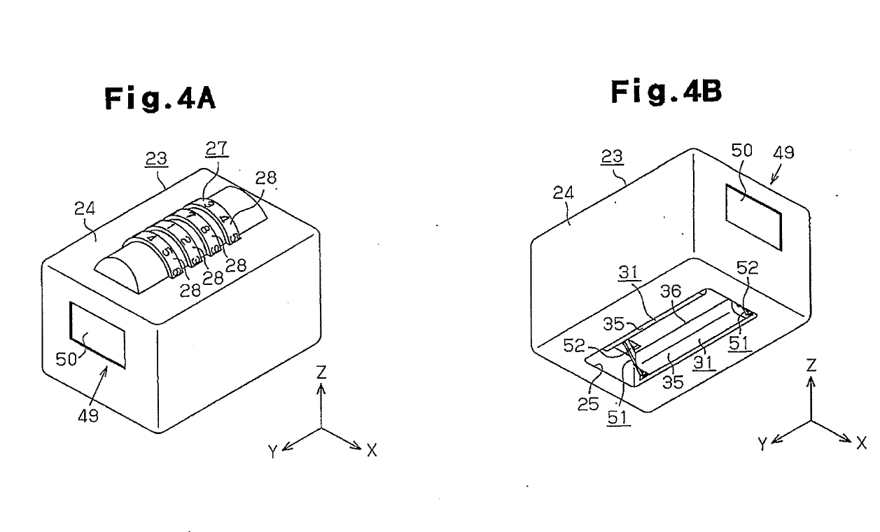

As shown in FIGS. 4 to 8, the power supplying plug lock device 23 includes a case 24. The case 24 includes a bottom surface provided with a fitting hole 25, into which the arm operation portion 20 of the lock arm 17 may be fitted. The arm operation portion 20 is fitted into the fitting hole 25 to attach the power supplying plug lock device 23 to the power supplying plug 9.

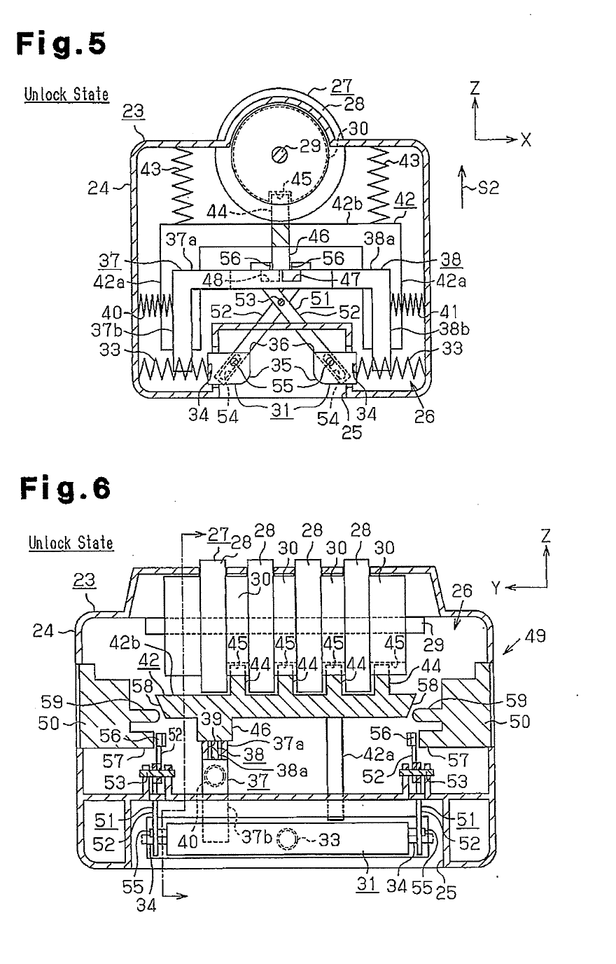

As shown in FIGS. 5 to 8, the case 24 includes a lock mechanism 26, which restricts movement of the lock arm 17. The lock mechanism 26 includes a dial cylinder 27, which is used for authentication. The dial cylinder 27 includes dials 28, which are arranged in a line along the longitudinal direction of the lock device 23 (in FIG. 6, the Y direction). The dials 28 are supported to be rotatable about a dial shaft 29. Each dial 28 includes a dial coupling gear 30, which includes a notch formed at a predetermined location that is in accordance with a combination number, or authentication number, of the dial cylinder 27. The dial cylinder 27 is one example of an authentication member.

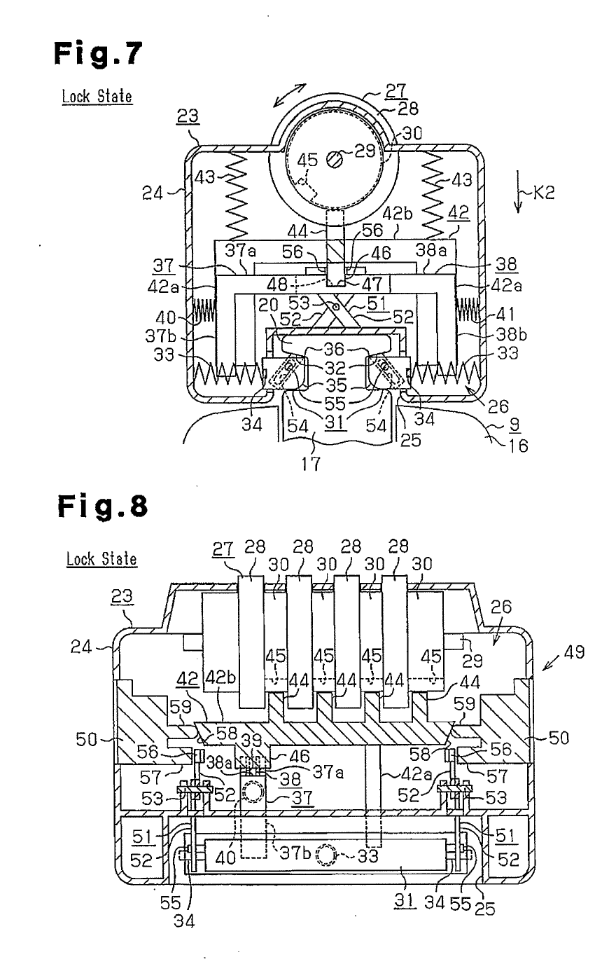

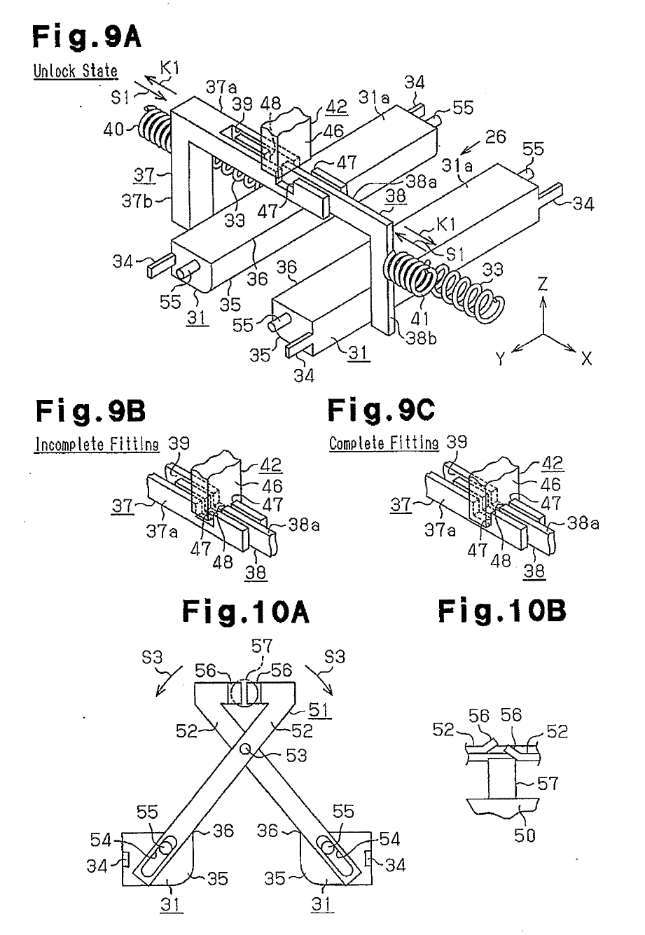

The lock mechanism 26 includes two opposing restriction members 31, which are engaged with the arm operation portion 20. The restriction members 31 serves as latches and are linearly movable back and fourth in the lateral direction of the lock device 23 (in FIG. 5, the X direction). Each restriction member 31 includes an inner end surface that is exposed from the fitting hole 25. As shown in FIG. 7, when the power supplying plug lock device 23 is attached to the arm operation portion 20, the inner end surfaces of the two restriction members 31 are inserted into engagement holes 32, which are formed in the two side surfaces of the arm operation portion 20. Further, each restriction member 31 includes an outer end surface coupled to an urging member 33, which urges the restriction member 31 inward into the case 24, that is, toward the fitting hole 25. As shown in FIG. 9A, a stopper 34 projects from the outer end surface of each restriction member 31 to prevent removal of the restriction member 31 from the case 24.

As shown in FIG. 5, one corner in the lower surface of each restriction member 31 defines a guide surface 35, which allows the restriction member 31 to smoothly move into the arm operation portion 20. The guide surface 35 is formed by curving one corner in the lower surface of the restriction member 31. Further, one corner in the upper surface of each restriction member 31 defines a separation prevention corner 36 that results in the restriction member 31 resisting removal from the engagement hole 32 of the arm operation portion 20. That is, the separation prevention corner 36 prevents the restriction member 31 from easily separating from the arm operation portion 20. The separation prevention corner 36 is formed by one corner on the upper surface formed having an angle of about 90 degrees.

As shown in FIGS. 5 and 9A, the lock mechanism 26 includes first and second locking bars 37 and 38, which are linearly movable back and fourth in the lateral direction (X direction). The first and second locking bars 37 and 38 may support the corresponding restriction members 31 from the outer side. Further, the locking bars 37 and 38 are generally L-shaped and symmetric to each other in the lateral direction when viewed from the front. The first and second locking bars 37 and 38 are examples of a lock member.

As shown in FIGS. 9A to 9C, the first and second locking bars 37 and 38 include coupling pieces 37a and 38a, respectively. The coupling piece 37a includes a rail portion 39 into which the coupling piece 38a is fitted. Thus, the first and second locking bars 37 and 38 are linearly moved toward and away from each other in the lateral direction (X direction) along the rail portion 39.

Further, the first and second locking bars 37 and 38 respectively include support pieces 37b and 38b, which extend in the vertical direction of the lock device 23 (in FIG. 9A, the Z direction). The support pieces 37b and 38b may support the corresponding restriction members 31 from the outer side. As shown in FIG. 5, an urging member 40 is arranged between the inner surface of the case 24 and the support piece 37b to urge the first locking bar 37 in the inward direction. In the same manner, an urging member 41 is arranged between the inner surface of the case 24 and the support piece 38b to urge the second locking bar 38 in the inward direction.

When the restriction members 31 move away from each other in an opening direction (in FIG. 9A, the direction of arrow K1), the first and second locking bars 37 and 38 are pushed by and moved integrally with the restriction members 31 in the opening direction. When force in the opening direction is not applied, the restriction members 31 are moved toward each other in a closing direction (in FIG. 9A, the direction of arrow S1) by the urging force of the urging members 33. In this case, the first and second locking bars 37 and 38 are also moved toward each other in the closing direction (in FIG. 9A, the direction of arrow S1) by the urging force of the corresponding urging members 40 and 41.

As shown in FIGS. 5 to 8, the lock mechanism 26 includes a lock plate 42 that cooperates with the locking bars 37 and 38 to shift the lock mechanism 26 to a lock state. The lock plate 42 is arranged to be linearly movable back and fourth in the vertical direction (in FIG. 5, the Z direction). Two urging members 43 are arranged between the inner surface of the case 24 and the lock plate 42. The lock plate 42 includes two restriction pieces 42a that may support the corresponding restriction members 31 from the outer side. As shown in FIG. 7, the urging force of the urging members 43 moves the lock plate 42 in a lock direction (in FIG. 7, the direction of arrow K2). When each restriction piece 42a is arranged at the outer side of the corresponding restriction member 31, movement of the restriction member 31 in the opening direction is restricted. Accordingly, each restriction member 31 is held at a projected position (close position). The lock plate 42 is one example of a movable member. In this example, the locking bars 37 and 38, the lock plate 42, and the urging members 33, 40, 41, and 43 form a position holding mechanism.

As shown in FIG. 5, the lock plate 42 includes a main body portion 42b, which serves as an upper piece that couples the two restriction pieces 42a. The main body portion 42b includes an upper surface from which projections 44 project toward the dials 28. The projections 44 are arranged in correspondence with the dials 28 so that one of the projections 44 corresponds with one of the dials 28. The projections 44 are aligned along the dial shaft 29. Each projection 44 may be engaged with a notch 45 formed in the dial coupling gear 30 of the corresponding dial 28. When the dials 28 are arranged so that their combination of numbers is correct, the notches 45 are aligned along the dial shaft 29. In this state, the projections 44 may enter the corresponding notches 45. This permits vertical movement of the lock plate 42.

As shown in FIGS. 5 and 6, the main body portion 42b of the lock plate 42 includes a lower surface from which a plate-shaped projection 46 projects toward the locking bars 37 and 38. As shown in FIG. 9A, an upper surface of the coupling piece 37a in the first locking bar 37 includes a fitting groove 47. The projection 46 may be fitted to the fitting groove 47 from above. In the same manner, an upper surface of the coupling piece 38a in the second locking bar 38 includes a fitting groove 48, which is similar to the fitting groove 47. As shown in FIG. 9A, when the locking bars 37 and 38 move toward each other in the closing direction, the fitting grooves 47 and 48 are not in alignment. In this state, the projection 46 comes into contact with the upper surfaces of the coupling pieces 37a and 38a and is not fitted to the fitting grooves 47 and 48. As shown in FIGS. 9B and 9C, when the locking bars 37 and 38 move away from each other in the opening direction, the fitting grooves 47 and 48 are aligned with each other, and the projection 46 may be fitted into the fitting grooves 47 and 48. In this state, the lock plate 42 holds the locking bars 37 and 38 at a retracted position and restricts movement of the restriction members 31 in the opening direction.

As shown in FIGS. 5 and 6, when the projection 46 of the lock plate 42 is not fitted to the fitting grooves 47 and 48 of the locking bars 37 and 38, movement of the restriction members 31 is permitted. In this case, the power supplying plug lock device 23 (lock mechanism 26) is in an unlock state. As shown in FIGS. 7 and 8, when the locking bars 37 and 38 move away from each other in the opening direction and the fitting grooves 47 and 48 are aligned with each other, the lock plate 42 is lowered by the urging force of the urging members 43 and the projection 46 enters the fitting grooves 47 and 48. In this state, the restriction pieces 42a of the lock plate 42 are located at the outer side of the corresponding restriction member 31. Thus, movement of each restriction member 31 in the opening direction is restricted by the lock plate 42. In this case, the power supplying plug lock device 23 (lock mechanism 26) is in a lock state.

As shown in FIGS. 4, 6, and 8, the power supplying plug lock device 23 further includes an unlock portion 49 that is operated to release the lock mechanism 26 from a lock mechanism 26 and return the lock mechanism 26 to an unlock state. In this example, as the unlock portion 49, two push type unlock buttons 50 are arranged on two side surfaces of the case 24 in the longitudinal direction of the lock device 23 (in FIG. 6, the Y direction). The unlock portion 49 is operated, for example, by holding the two unlock buttons 50 so that the index finger comes into contact with one of the unlock buttons 50 and the thumb comes into contact with the other one of the unlock buttons 50.

As shown in FIGS. 6 and 8, each unlock button 50 is coupled to the restriction members 31 by a link mechanism 51. As shown in FIG. 10A, each link mechanism 51 includes two link members 52 that intersect with each other. The link members 52 are pivotally coupled to the case 24 about a pivot shaft 53, which is arranged at where the link members 52 intersect each other. An elongated hole 54 extends through a lower end of each link member 52. A coupling projection 55 (refer to FIG. 9A), which is formed on the end surface of each restriction member 31, is inserted into each elongated hole 54.

As shown in FIG. 10B, an upper end of each link member 52 defines a pushing surface 56 that pushes the pushed unlock button 50 back to its original position. Each pushing surface 56 is formed by inwardly bending the upper end of the link member 52. The two link members 52 are coupled to each other so that the opposing pushing surfaces 56 form a tapered ridge. The pushing surfaces 56 may be pushed by a pushing pin 57 that is formed on a lower portion of the corresponding unlock button 50.

As shown in FIGS. 6 and 8, the lock plate 42 has two end surfaces in the longitudinal direction (in FIG. 6, the Y direction) defining sloped surfaces 58 that are inclined downward. Each unlock button 50 includes a lifting portion 59 that may push the corresponding sloped surface 58. The lifting portion 59 projects from the unlock button 50 above the pushing pin 57.

When the power supplying plug lock device 23 is in the lock state (FIG. 8) and the two unlock buttons 50 are pushed, the pushing pins 57 push the pushing surfaces 56 of the corresponding link mechanism 51. Thus, the link members 52 of each link mechanism 51 are pivoted in the opening direction (in FIG. 10A, the direction of arrow S3). As a result, the restriction members 31 are moved away from each other in the opening direction (in FIG. 9A, the direction of arrow K1). Further, the lifting portion 59 of each unlock button 50 pushes the corresponding sloped surface 58 of the lock plate 42. This linearly moves the lock plate 42 upward, that is, in the unlock direction (in FIG. 5, the direction of arrow S2).

The operation of the power supplying plug lock device 23 will now be described with reference to FIGS. 5 to 12.

When the power supplying plug lock device 23 is not attached to the power supplying plug 9, the power supplying plug lock device 23 is in an unlock state as shown in FIGS. 5 and 6. In this state, the dials 28 are arranged so that their combination of numbers is correct, and the notches 45 are aligned parallel to the dial shaft 29. Thus, the projections 44 are all arranged in the notches 45. The projection 46 of the lock plate 42 is arranged on the upper surface of the locking bars 37 and 38, and the lock plate 42 is lifted in the unlock direction (in FIG. 5, the direction of arrow S2). That is, the lock plate 42 is held at the unlock position.

When the lock plate 42 is located at the unlock position, each restriction piece 42a is separated from the outer rear side of the corresponding restriction member 31. Accordingly, each restriction member 31 is not in a lock state. That is, the restriction members 31 are linearly movable away from each other in the opening direction (in FIG. 9A, the direction of arrow K1). In this state, the lock plate 42 is urged in the lock direction (downward direction) by the urging members 43. However, as shown in FIG. 9A, the projection 46 is located above the coupling pieces 37a and 38a of the locking bars 37 and 38 and not fitted to the fitting grooves 47 and 48. Thus, the lock plate 42 is held at an unlock position.

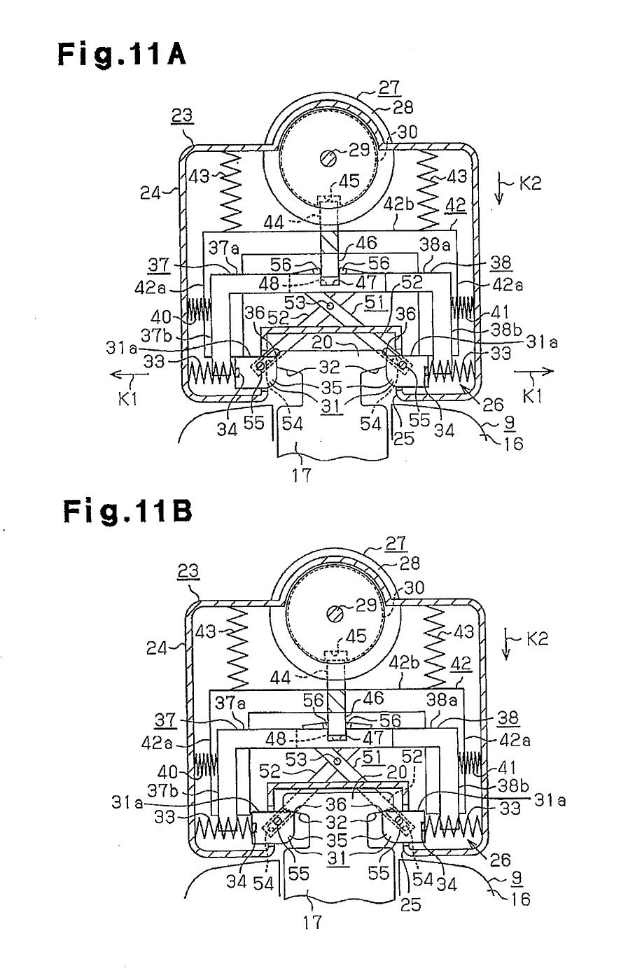

To lock the power supplying plug 9 to the inlet 14, the power supplying plug lock device 23 is attached to the arm operation portion 20 of the lock arm 17. As shown in FIG. 11A, when the arm operation portion 20 enters the fitting hole 25, the restriction members 31 are pushed by the arm operation portion 20 and moved away from each other in the opening direction (in FIG. 11A, the direction of arrow K1). In this state, the first and second locking bars 37 and 38 are also pushed by the restriction members 31 and moved away from each other in the opening direction.

When the movement of the first and second locking bars 37 and 38 aligns the two fitting grooves 47 and 48, the lock plate 42 becomes movable in the lock direction. Here, the lock plate 42 is moved in the lock direction by the urging force of the urging members 43. However, as shown in FIG. 11A, before the arm operation portion 20 is completely fitted into the fitting hole 25, that is, when each restriction member 31 is located at an open position and not arranged in the corresponding engagement hole 32 of the arm operation portion 20, the projection 46 of the lock plate 42 is not completely fitted to the fitting grooves 47 and 48. In this state, each restriction piece 42a of the lock plate 42 comes into contact with the upper surface 31a of the corresponding restriction member 31. This restricts movement of the lock plate 42 in the lock direction. Accordingly, the lock plate 42 cannot be lowered to the lowermost position. Thus, as shown in FIGS. 9B and 11A, the lock plate 42 is in an incomplete fitting state in which the projection 46 is incompletely fitted to the fitting grooves 47 and 48.

In the incomplete fitting state, the locking bars 37 and 38 are held at the retracted positions. However, the lock plate 42 is arranged on the upper surfaces 31a of the restriction members 31 and thus does not reach the lock position. When the restriction members 31 move to the open position, the upper surfaces 31a of the restriction members 31 restrict movement of the lock plate 42 to the lock position. Thus, the upper surfaces 31a function as restriction surfaces that maintain the lock plate 42 in a state incompletely fitted to the locking bars 37 and 38. Before the lock device 23 is attached to the power supplying plug 9, the restriction surfaces (upper surfaces 31a) prevent the lock device 23 from inadvertently shifting to a lock state. For example, during the attachment of the lock device 23, even when the user touches and slightly moves the restriction members 31, the restriction surfaces (upper surfaces 31a) keep the lock plate 42 in an incompletely fitted state. This prevents the lock device 23 from being inadvertently shifted to a lock state.

As shown in FIG. 11B, when the arm operation portion 20 is further inserted into the fitting hole 25, the restriction members 31 are moved in the closing direction by the corresponding urging members 33. As shown in FIG. 7, when the restriction members 31 are completely fitted to the engagement holes 32 of the arm operation portion 20 and reach the close positions, the lock plate 42 is released from the restriction imposed by the upper surface 31a (restriction surface) of each restriction member 31. Thus, the urging force of the urging members 43 moves the lock plate in the lock direction. As a result, as shown in FIG. 9C, the lock plate 42 enters a completely fitted state in which the projection 46 is completely fitted to the fitting grooves 47 and 48.

As shown in FIGS. 7 and 8, in the completely fitted state, the restriction pieces 42a of the lock plate 42 are located at the outer side of the corresponding restriction members 31. This restricts movement of the restriction members 31 in the opening direction. That is, the lock plate 42 is located at the lock position, and each restriction member 31 is held at a projected position (closing position). This maintains the lock device 23 in the lock state. Here, the projections 44 of the lock plate 42 are removed from the notches 45 thereby allowing for rotation of the dials 28. Thus, the user may turn each dial 28 to obtain any combination of numbers and thereby hide the correct combination. If the combination of numbers of the dials 28 is not correct, the projections 44 of the lock plate 42 cannot enter the notches 45 even when the unlock buttons 50 are pushed. This prevents an unauthorized person from performing unlocking.

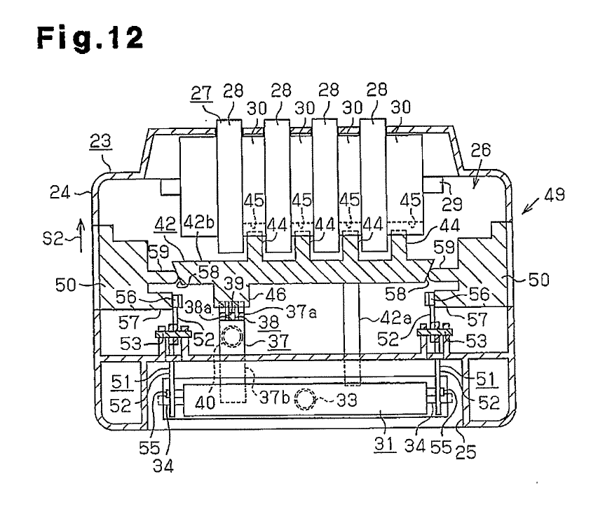

When releasing the power supplying plug lock device 23 from the lock state, as shown in FIG. 12, the numbers of the dials 28 are set to the correct combination, and the two unlock buttons 50 are then simultaneously pushed. Here, the lifting portions 59 push the sloped surfaces 58 upward and move the lock plate 42 in the unlock direction (in FIG. 12, the direction of arrow S2). Accordingly, the restriction pieces 42a of the lock plate 42 move away from the outer side of the corresponding restriction members 31. This releases the lock device 23 from the lock state.

At the same time, the projection 46 of the lock plate 42 is removed from the fitting grooves 47 and 48. Thus, the first and second locking bars 37 and 38 are moved in the closing direction (in FIG. 9A, the direction of arrow S1) by the urging members 40 and 41 and returned to their original initial positions. As a result, the lock device 23 returns to an unlock state in which the projection 46 of the lock plate 42 is located on the coupling pieces 37a and 38a.

Further, when the two unlock buttons 50 are pushed, the pushing pins 57 push the two pushing surfaces 56 thereby pivoting the corresponding link mechanism 51 in the open direction (in FIG. 10A, the direction of arrow S3). As a result, the restriction members 31 move away from each other in the opening direction (in FIG. 9A, the direction of arrow K1). This separates the restriction members 31 from the engagement holes 32 of the arm operation portion 20. Thus, the power supplying plug lock device 23 may be removed from the arm operation portion 20. In this state, the power supplying plug lock device 23 may be removed from the arm operation portion 20 by pushing the two unlock buttons 50.

In the present embodiment, the power supplying plug 9 may be locked to the inlet 14 just by attaching the power supplying plug lock device 23 to the arm operation portion 20 of the lock arm 17. This facilitates the locking of the power supplying plug 9. Further, the power supplying plug 9 is locked with the power supplying plug lock device 23, which is a dedicated lock. Thus, only the authorized user who possesses the lock device 23 may lock the power supplying plug 9. This prevents an unauthorized person from locking the power supplying plug 9.

The power supplying plug lock device 23 of the present embodiment has the advantages described below.

(1) The power supplying plug 9 may be locked to the inlet 14 just by attaching the power supplying plug lock device 23 to the arm operation portion 20 of the lock arm 17. This allows the power supplying plug 9 to be locked to the inlet 14 just by performing a simple task of setting the power supplying plug lock device 23 onto the arm operation portion 20. Further, the power supplying plug lock device 23 of the present example, or the dedicated lock device, is required to lock the power supplying plug 9. Thus, the power supplying plug 9 may be locked with a widely used padlock or the like. This prevents an unauthorized person from locking the power supplying plug 9 in an unauthorized manner.
(2) The power supplying plug lock device 23 does not enter the lock state unless the two restriction members 31 are simultaneously pushed in the open direction. Thus, even if one of the two restriction members 31 is inadvertently pushed, the power supplying plug lock device does not enter the lock state. This prevents inadvertent switching to the lock state.
(3) The lock plate 42, the two locking bars 37 and 38, and the urging members 33, 40, 41, and 34 are used to hold the restriction members 31 in the lock state. Thus, the power supplying plug 9 may be locked to the inlet 14 with a simple structure using these components.
(4) The power supplying plug lock device 23 includes the unlock portion 49. Operation of the unlock portion 49 switches the power supplying plug lock device 23 from the lock state to the unlock state. Thus, the power supplying plug lock device 23 may easily be removed from the lock arm 17.
(5) The guide surface 35 is arranged on the lower surface of each restriction member 31. Thus, when attaching the power supplying plug lock device 23 to the arm operation portion 20, the guide surface 35 guides movement of the restriction member 31 in the opening direction. This allows for smooth attachment of the power supplying plug lock device 23 to the arm operation portion 20.

It should be apparent to those skilled in the art that the present invention may be embodied in many other specific forms without departing from the scope of the invention. Particularly, it should be understood that the present invention may be embodied in the following forms.

The power supplying plug lock device 23 is not limited to a structure that is engaged with the engagement holes 32 of the arm operation portion 20. For example, the arm operation portion 20 may include a protrusion that forms a step, and the power supplying plug lock device 23 may be engaged with the step.

The authentication member is not limited to the dial cylinder 27 and may be, for example, a key cylinder. Alternatively, the authentication member may perform electronic authentication.

Although only the lower surface of each restriction member 31 is curved in the above embodiment, the upper surface and the lower surface of the restriction member 31 may both be curved.

The restriction members 31, the urging members 33, the lock members (locking bars 37 and 38), the urging members 40 and 41, and the urging members 43 do not necessarily have to be arranged in pairs. For example, just one of the two restriction members 31 may be engaged with the arm operation portion 20. In this case, the other parts related with the restriction member 31 may also be provided as a single component. More specifically, just one of the two urging members 33, just one of the locking bars 37 and 38, just one of the urging members 40 and 41, and just one of the urging members 43 need be used.

The operation arm is not limited to the lock arm 17, which includes a pivot shaft arranged in a longitudinally middle portion. For example, the lock arm 17 may have a pivot shaft arranged at one of its longitudinal ends.

In the above embodiment, the position holding mechanism uses the lock plate 42 and the two locking bars 37 and 38. The shapes of the lock plate 42 and locking bars 37 and 38 may be changed as required. Further, the number and location of the urging members used for the position holding mechanism may be changed as required.

The unlock buttons 50 do not have to be arranged as a pair. For example, there may be just one unlock button 50.

The unlock portion 49 is not limited to the two unlock buttons 50 and may have another structure. For example, the unlock portion 49 may be of an electric drive type.

The urging members 33, 40, 41, and 43 are not limited to springs and may be changed to other members.

The vehicle 1 is not limited to a hybrid vehicle and may be an electric vehicle driven by just a motor.

The present examples and embodiments are to be considered as illustrative and not restrictive, and the invention is not to be limited to the details given herein, but may be modified within the scope and equivalence of the appended claims.

1. A power supplying plug lock device attachable to an operation arm of a power supplying plug, the operation arm operable to fix the power supplying plug to an inlet, the power supplying plug lock device configured to restrict movement of the operation arm to prevent unauthorized removal of the power supplying plug, the power supplying plug lock device characterized by comprising:
an authentication member used for authentication;
a restriction member that is engageable with the operation arm; and
a position holding mechanism that is able to hold the restriction member at a position engaged with the operation arm, wherein
the power supplying plug lock device is externally attachable to the operation arm when the authentication member accomplishes authentication,
the restriction member is configured to move from an open position to a close position to engage with the operation arm by attachment of the power supplying plug lock device to the operation arm, and
the position holding mechanism is configured to shift from an unlock state to a lock state in cooperation with the movement of the restriction member from the open position to the close position thereby holding the restriction member at the close position and to maintain the lock state until the authentication member again accomplishes authentication.

2. The power supplying plug lock device according to claim 1, wherein
the restriction member is one of two restriction members arranged to move toward and away from each other, and
the position holding mechanism is configured to be shifted to the lock state when the two restriction members are both moved.

3. The power supplying plug lock device according to claim 1, wherein the position holding mechanism includes:
a movable member movable between an unlock position and a lock position and configured to be coupled to the authentication member at the unlock position and restrict movement of the restriction member at the lock position;
a lock member movable between a first position and a second position and configured to permit movement of the movable member to the lock position when located at the second position; and
an urging member that is configured to urge the movable member from the unlock position to the lock position,
wherein the movable member is configured to start movement from the unlock position to the lock position with an urging force of the urging member when the restriction member moves to the open position and fix the lock member at the second position to hold the restriction member at the close position when located at the lock position.

4. The power supplying plug lock device according to claim 3, wherein:
the lock member includes a fitting groove into which the movable member is fitted; and
the restriction member includes a restriction surface that restricts, when the restriction member moves to the open position, movement of the movable member to the lock position to maintain the movable member in a state incompletely fitted to the fitting groove of the lock member.

5. The power supplying plug lock device according to claim 3, wherein
the movable member is a single component, and
the lock member is one of two lock members fixed at the second position by the movable member.

6. The power supplying plug lock device according to claim 1, further comprising an unlock portion operated to release the position holding mechanism from the lock state and return the position holding mechanism to the unlock state.

7. The power supplying plug lock device according to claim 1, wherein the restriction member includes a curved guide surface that guides the movement of the restriction member when the restriction member is engaged with the operation arm.

8. The power supplying plug lock device according to claim 1, wherein the restriction member includes a separation prevention corner that prevents separation of the operation arm from the restriction member held at the close position.

9. The power supplying plug lock device according to claim 1, wherein the position holding mechanism includes:
a movable member movable between an unlock position and a lock position and configured to be coupled to the authentication member at the unlock position and restrict movement of the restriction member at the lock position;
a lock member movable between a first position and a second position and configured to permit movement of the movable member to the lock position when located at the second position; and
an urging member that is configured to urge the movable member from the unlock position to the lock position,
wherein the movable member is configured to:
start moving from the unlock position to the lock position with an urging force of the urging member when the restriction member moves to the open position;
be incompletely fitted to the lock member thereby fixing the lock member at the second position when the restriction member is located at the open position;
finish movement to the lock position when the restriction member moves from the open position to the close position; and
be completely fitted to the lock member thereby holding the restriction member at the close position when the movable member is located at the lock position.

10. The power supplying plug lock device according to claim 6, wherein:
the unlock portion includes an unlock button operated by a user; and
when the unlock button is operated, the unlock portion switches the position holding mechanism from the lock state to the unlock state and moves the restriction member from the close position to the open position.

11. The power supplying plug lock device according to claim 1, wherein the authentication member is a dial cylinder including a plurality of dials used to set an authentication number.
